(19) United States
(12) Patent Application Publication
(10) Pub. No.: US 2013/0260095 A1
(43) Pub. Date: Oct. 3, 2013

(54) GLASS SUBSTRATE HAVING FINE STRUCTURES ON THE SURFACE THEREOF

(71) Applicant: HITACHI, LTD., Tokyo (JP)

(72) Inventors: Yuzuru SHIMAZAKI, Tokai (JP); Takashi NAITO, Funabashi (JP); Takuya AOYAGI, Mito (JP); Yuichi SAWAI, Mito (JP); Tadashi FUJIEDA, Mito (JP); Akihiro MIYAUCHI, Hitachi (JP); Masahiko OGINO, Hitachi (JP)

(73) Assignee: HITACHI, LTD., Tokyo (JP)

(21) Appl. No.: 13/770,722

(22) Filed: Feb. 19, 2013

(30) Foreign Application Priority Data
Mar. 30, 2012 (JP) 2012-078801

(51) Int. Cl. C03C 4/00

(52) U.S. Cl. CPC C03C 4/00
USPC 428/141; 250/338.1; 362/363

(57) ABSTRACT

A glass substrate having a fine structure on the surface thereof, wherein said glass substrate is made of vanadium-containing glass and said vanadium-containing glass has a resistivity no higher than 10⁹ Ω·cm, with the content of vanadium (in the form of V₂O₅) being no less than 10 wt % and no more than 60 wt %. The glass substrate prevents dust attraction and retains its antifouling properties over a long period of time.

### BACKGROUND OF THE INVENTION

1. Field of the Invention

The present invention relates to a glass substrate having fine structures on the surface thereof.

2. Description of the Related Art

There has long been a continued development in the technology of protecting the surface of structures and glass from fouling, and there will be continued demand for such technology in the future. According to typical examples of conventional technologies, the foregoing object is achieved by any one of the following.

(i) Coating the surface with a TiO₂-containing compound which decomposes organic matter adhering to the surface by means of UV light.
(ii) Coating the surface with a fluorine-based organic material which lowers the surface energy, thereby making the surface less prone to dust attraction (as disclosed in JP-2007-25508-A, for example).
(iii) Coating the surface with a compound containing hydrophilic SiO₂ nano-particles which increases the hydrophilic surface area, thereby reducing the adhesion of hydrophobic organic matter to the surface (as disclosed in JP-2011-153195-A, for example).

### SUMMARY OF THE INVENTION

The conventional technologies mentioned above suffer a disadvantage of deteriorating in antifouling function with time on account of the deterioration of the coating compound or the detachment of the coating compound form the underlying layer. Another disadvantage is that the antifouling coating layer formed by the above-mentioned technologies is an insulating body, whose surface becomes charged with static electricity and inevitably attracts dust. Thus, there has been a demand for a new technology to avoid dust attraction.

It is an object of the present invention to provide a glass substrate which not only avoids dust attraction but also retains the anti-soling function over a long period of time.

In order to solve the above mentioned problems, the present invention provides a glass substrate having a fine structure on the surface thereof, wherein said glass substrate is made of glass containing vanadium and said vanadium-containing glass has a resistivity no higher than 10⁹ Ω·cm.

The glass substrate according to the present invention avoids dust adhesion and retains the antifouling function over a long period of time.

### BRIEF DESCRIPTION OF THE DRAWINGS

Other objects and advantages of the invention will become apparent from the following description of embodiments with reference to the accompanying drawings in which:

FIG. 1 is a schematic diagram showing the appearance of an infrared sensor;

FIG. 2 is a schematic diagram showing the appearance of an illuminating lamp;

FIG. 3 is a schematic diagram showing the mold “H”;

FIG. 4 is a schematic diagram showing the mold “M”;

FIG. 5 is a schematic diagram showing the mold “L”;

FIG. 6 is a schematic diagram showing the structure of the glass substrate produced by using the mold “H”;

FIG. 7 is a schematic diagram showing the structure of the glass substrate produced by using the mold “M”;

FIG. 8 is a schematic diagram showing the structure of the glass substrate produced by using the mold “L”;

FIG. 9 is a schematic diagram showing the appearance of an example of antifouling glass;

FIG. 10 is a schematic diagram showing the appearance of an infrared sensor and its sensor window glass; and

FIG. 11 is a schematic diagram showing the appearance of an illuminating lamp and its cover glass.

### DESCRIPTION OF THE PREFERRED EMBODIMENTS

The glass substrate according to the present invention is composed of a base of vanadium-containing glass and a surface layer with fine structure. The vanadium-containing glass is not specifically restricted so long as it is hydrophilic and has a resistivity no higher than 10⁹ Ω·cm. If the vanadium-containing glass has a resistivity higher than 10⁹ Ω·cm, the resulting glass substrate tends to generate static electricity on its surface, which leads to easy dust attraction. In addition, the vanadium-containing glass should preferably contain V₂O₅ in an amount no less than 10 wt % and no more than 60 wt %. A V₂O₅ content less than 10 wt % is not enough to produce sufficient conductivity and hence tends to generate static electricity on the surface of the glass substrate. This leads to easy dust attraction. A V₂O₅ content more than 60 wt % makes the glass substrate prone to moisture absorption to such an extent that it is of no practical use. Moreover, the vanadium-containing glass may additionally contain a variety of oxides for improvement in its performance. Examples of such oxides include P₂O₅, TeO₂, Fe₂O₃, MnO₂, ZnO, WO₃, MoO₂, BaO, and Ag₂O.

The glass substrate according to the present invention should have a fine structure on the surface thereof. It is only necessary that, in this fine structure, a hydrophilic surface having a surface area enough to provide antifouling function is exposed to the outside. It may be a rough surface composed of regularly arranged minute pillars, grooves, or semi-globules. Each constituent of the rough surface should have a minimum size no larger than 50 μm, preferably no larger than 10 μm. The shape of the fine structure varies depending on the use of the glass substrate. The minimum size denotes any of width, diameter, height, and depth of peaks and valleys which is smallest. Incidentally, the glass substrate according to the present invention deteriorates very little in antifouling function after a lapse of time because the fine structure thereof remains almost intact over a long period of time. Consequently, the present invention provides a glass substrate which avoids dust attraction and keeps its antifouling function over a long period of time.

The glass substrate according to the present invention may be produced by two steps of (1) preparing vanadium-containing glass and (2) forming the fine structure on the surface layer thereof. The first step of preparing vanadium-containing glass is not specifically restricted so long as it is capable of preparing glass containing V₂O₅ in an amount no less than 10 wt % and no more than 60 wt %. It is typically accomplished by mixing and melting together raw materials in a crucible at a high temperature. The second step of forming the fine structure on the surface layer of the vanadium-containing glass is not specifically restricted so long as it is capable of forming the fine structure suitable for specific uses. Techniques for the second step include, for example, sandblasting, chemical etching, dry etching, and nanoimprinting. Sandblasting, chemical etching, and dry etching can be applied to curved surfaces.

The glass substrate according to the present invention will find use as antifouling glass for infrared sensors and illuminating lamps. Thus it protects said devices from dust adhesion.

The glass substrate according to the present invention prevents dust attraction and keeps its antifouling performance over a long period of time. In the case where it is used as antifouling glass, the V₂O₅ content in the vanadium-containing glass should preferably be no lower than 10 wt % and no higher than 50 wt %. The V₂O₅ content should be lower than that of ordinary glass substrate, because the antifouling glass is frequently exposed to rain and snow. A V₂O₅ content in excess of 50 wt % results in glass having impractically high moisture absorption. By contrast, a V₂O₅ content less than 10 wt % leads to glass poor in conductivity, and hence the resulting glass substrate easily accumulates static electricity on its surface, thereby causing dust attraction. On the other hand, if the antifouling glass needs to have optical transparency, the glass substrate according to the present invention should undergo heat treatment so that it transmits light having a wavelength no shorter than 600 nm. If the glass substrate according to the present invention is to be used as antifouling glass, the object may be achieved by coating a sheet of float glass with a paste (composed of powder of the raw materials of the glass substrate, resin binder, and solvent), forming the fine structure, and then heating the fine structure. The glass substrate according to the present invention may be used as such for the antifouling glass. Alternatively, it may be used for curved antifouling glass sheets if it undergoes sandblasting, chemical etching, or dry etching.

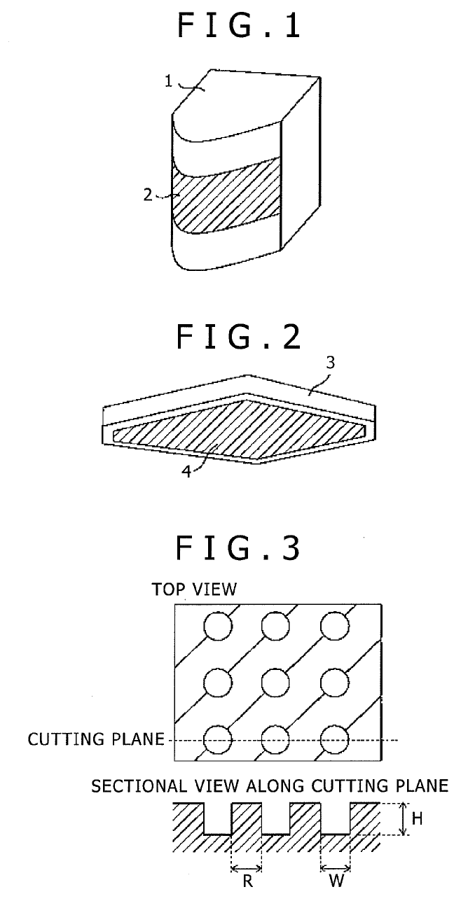

The glass substrate according to the present invention transmits infrared rays (having a wavelength of 0.8 to 8 μm); therefore, it can be used for the window of infrared sensors, which will remain clean without dust attraction for a long period of time, thereby allowing the infrared sensor to keep its initial sensitivity. The infrared sensor may be equipped with a detector capable of detecting infrared rays having a wavelength of 0.8 to 8 m. Examples of such detectors include InGaAs photodiode, InGaAsP photodiode, and InSb photodiode. In the case where the infrared sensor is installed at a position where the sensor's window is exposed to rain and snow, the glass substrate should be formed from vanadium-containing glass whose V₂O₅ content is lower than that of ordinary one. That is, it should be no lower than 10 wt % and no higher than 50 wt %. A V₂O₅ content in excess of 50 wt % results in glass having impractically high moisture absorption. By contrast, a V₂O₅ content less than 10 wt % leads to glass poor in conductivity, and hence the resulting glass substrate easily accumulates static electricity on its surface, thereby causing dust attraction. If the glass substrate according to the present invention is to be used as the window of infrared sensors, the object may be achieved by coating the sensor window with a paste (composed of powder of the raw materials of the glass substrate, resin binder, and solvent), forming the fine structure, and then heating the fine structure. The glass substrate according to the present invention may be used as such for the sensor window. Alternatively, it may be used for curved sensor windows if it undergoes sandblasting, chemical etching, or dry etching. The glass substrate according to the present invention may be freely applied to the infrared sensor which is composed of the casing 1 and the sensor window 2, as shown in FIG. 1.

The glass substrate according to the present invention may be used as the cover glass of illuminating lamps which is required to have a minimum tendency toward dust attraction and to remain clean over a long period of time. Therefore, the present invention provides illuminating lamps which will not remarkably decrease in illuminating efficiency due to dust adhesion and staining. In the case where the glass substrate according to the present invention is used as the cover glass of illuminating lamps, it should preferably undergo heat treatment so that it transmits light having a wavelength no shorter than 600 nm. However, this heat treatment is not necessary if the illuminating lamp employs a light source emitting light having a wavelength no shorter than 600 nm. An example of such light source is a sodium lamp. In the case where the illuminating lamp of the present invention is installed at a position where it is exposed to rain and snow, the glass substrate should be formed from vanadium-containing glass whose V₂O₅ content is lower than that of ordinary one. That is, it should be no lower than 10 wt % and no higher than 50 wt %. A V₂O₅ content in excess of 50 wt % results in glass having impractically high moisture absorption. By contrast, a V₂O₅ content less than 10 wt % leads to glass poor in conductivity, and hence the resulting glass substrate easily accumulates static electricity on its surface, thereby causing dust attraction. If the glass substrate according to the present invention is to be used as the cover glass of illuminating lamps, the object may be achieved by coating the cover glass with a paste (composed of powder of the raw materials of the glass substrate, resin binder, and solvent), forming the fine structure, and then heating the fine structure. The glass substrate according to the present invention may be used as such for the cover glass. Alternatively, it may be used for curved cover glass if it undergoes sandblasting, chemical etching, or dry etching. The glass substrate according to the present invention may be freely applied to the illuminating lamp which is composed of the casing 3 and the cover glass 4, as shown in FIG. 2.

The present invention will be described further in the following with reference to Examples and Comparative Examples, which are not intended to restrict the scope thereof.

### <Preparation of Vanadium-Containing Glass>

Four kinds of vanadium-containing glass were prepared which have the composition and sag point as shown in Table 1. The composition shown in Table 1 is expressed in terms of oxide (by wt %). The raw materials for the glass are V₂O₅ as vanadium, P₂O₅ as phosphorus, TeO₂ as tellurium, Fe₂O₃ as iron, K₂O as potassium, ZnO as zinc, WO₃ as tungsten, MoO₃ as molybdenum, and Ba(PO₃)₂ as barium. Each sample of the vanadium-containing glass was prepared in the following way. The individual raw materials in the form of oxide, weighing about 150 to 200 g in total, were mixed together and placed in a platinum crucible, which was subsequently heated in an electric furnace up to 900-950° C. at a rate of 5-10° C./min and kept at the specified temperature for 1 hour. Incidentally, the sample V4 was heated at 1400° C. The content in the crucible was stirred to ensure uniformity during melting. After the crucible had been removed from the electric furnace, the molten content was poured into a graphite mold and also poured onto a stainless steel plate, both of which had previously been heated to about 150° C. In this way there was obtained the vanadium-containing glass as desired. The glass obtained by pouring onto a stainless steel plate was pulverized into powder having a particle diameter smaller than 20 μm. This powder was used to determine the sag point by differential thermal analysis (DTA) at a heating rate of 5° C./min.

TABLE 1
Composition and Sag Point of Vanadium-containing Glass

| | | | | | | | | | Sag |
|---|---|---|---|---|---|---|---|---|---|
| | Composition of glass (wt %) | | | | | | | | point |
| | V₂O₅ | P₂O₅ | TeO₂ | Fe₂O₃ | MnO₂ | K₂O | WO₃ | BaO | (° C.) |
| V1 | 60 | 20 | 10 | 5 | 5 | | | | 307 |
| V2 | 50 | 20 | 20 | | | 5 | 5 | | 316 |
| V3 | 38 | 5.8 | 30 | | | 5 | 10 | | 320 |
| V4 | 10 | 30 | | | | | 40 | 20 | 630 |

### <Formation of Fine Structure on the Surface of Vanadium-Containing Glass>

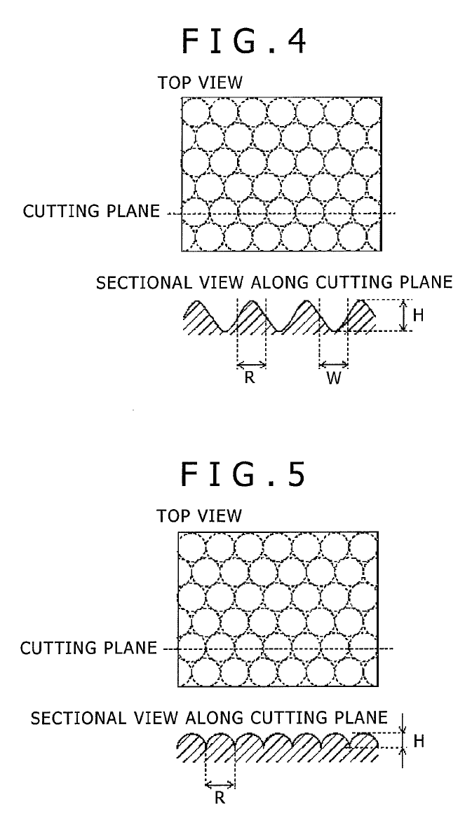

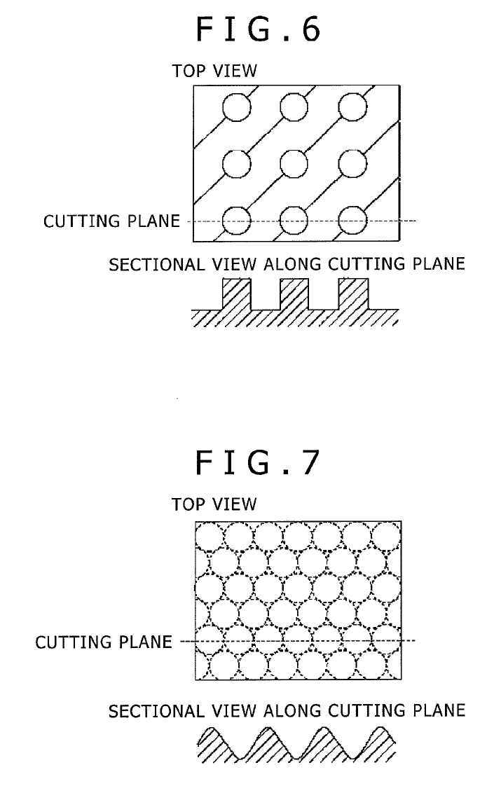

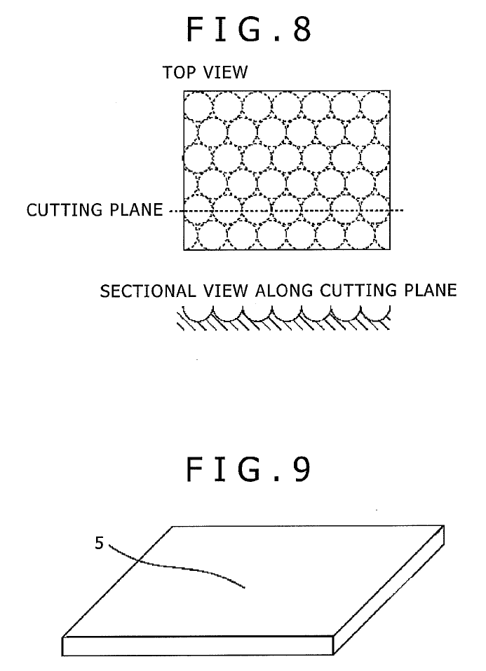

The vanadium-containing glass obtained as mentioned above underwent nanoimprinting so that a fine structure was formed on the surface thereof. The nanoimprinting was accomplished by pressing a carbon mold against each sample of V1, V2, V3, and V4. Thus, there were obtained samples of glass substrate each having a fine structure of varied kinds on the surface thereof. The mold is designated as “H” (hole type), “M” (moth eye type), and “L” (lens type), which are illustrated in FIGS. 3, 4, and 5, respectively. The letters (H, R, W) in these figures represent the parameters specific to the molds. During the step of pressing, each glass sample was kept at a temperature 10° C. higher than its sag point. In what follows, the glass substrate thus obtained will be identified by an abbreviation composed of glass name and mold name (e.g., V1−H1). The step of pressing was followed by demolding at 200° C. Table 2 shows the molds used and the mold parameters. In Comparative Example, there was prepared a sample of glass substrate by pressing a flat mold having no fine structure (designated as “P”) against glass. Observation under an atomic force microscope and scanning electron microscope indicated that all the samples of vanadium-containing glass have the surface fine structure transformed from the mold pattern. Examples of the fine structure formed by the molds “H”, “M”, and “L” are schematically shown in FIGS. 6, 7, and 8, respectively.

TABLE 2

| | | | |
|---|---|---|---|
| Designation | R (μm) | W (μm) | H (μm) |

Mold of hole type

| | | | |
|---|---|---|---|
| H1 | 2 | 2 | 1 |
| H2 | 0.5 | 0.5 | 0.5 |

Mold of moth eye type

| | | | |
|---|---|---|---|
| M1 | 2 | 2 | 1 |
| M2 | 0.5 | 0.5 | 0.5 |

Mold of lens type

| Designation | R (μm) | H (μm) |
|---|---|---|
| L1 | 2 | 1 |
| L2 | 0.5 | 0.25 |

Alternatively, each sample of the vanadium-containing glass (V1, V2, V3, V4) underwent sandblasting in the following way so that the fine structure was formed on the surface thereof. The vanadium-containing glass kept at a temperature 10° C. higher than its sag point was pressed and flattened under a flat mold (designated at “P”) having no fine structure. The thus flattened glass underwent sandblasting with aluminum oxide (325 mesh, made by Wako Junyaku Kogyo K.K.) at a pressure of 0.8 MPa for 10 seconds. The thus obtained glass substrate (having fine structure on the surface thereof) will be identified by a symbol abbreviated from glass name and S (e.g., V1−S). Observation under an atomic force microscope and scanning electron microscope indicated that all of the sandblasted samples have the surface fine structure having a maximum depth no larger, than 5 μm and projections no larger than 5 μm within the surface layer.

### <Preparation of Comparative Sample>

A sample of glass substrate for comparison (called C-1) was prepared from Tempax Float (registered trademark) (made by SCHOTT) by dipping in Optool DSX (registered trademark) solution (made by Daikin Kagaku K.K.) for 30 minutes, followed by heat treatment at 120° C. for 5 minutes. Tempax Float (registered trademark) is a glass substrate having a volume resistivity of 10¹⁵ Ω·cm and a clean surface finished by oxygen plasma treatment. Coating with Optool DSX (registered trademark) solution is intended to form a antifouling layer on the glass substrate.

### <Evaluation of Resistance to Dust Attraction and Fouling>

The samples (V1, V2, V3, V4) prepared in Examples were examined for resistivity by the four-terminal method. The results are shown in FIG. 3. It is noted that all of them have a resistivity lower than 10⁹ Ω·cm.

TABLE 3

| | V1 | V2 | V3 | V4 |
|---|---|---|---|---|
| Resistivity | <10⁷ | <10⁷ | <10⁷ | 5 × 10⁸ |
| (Ω · cm) | | | | |

The samples of glass substrate prepared in Examples were tested for resistance to dust attraction and fouling in the following manner. The results are shown in Table 4.

Resistance to dust attraction: Each sample (measuring 1 cm square) is allowed to stand indoors for two days, with that side having the fine structure upward. The result is expressed in terms of the number of dust particles larger than 0.5 mm which have adhered to the surface of the fine structure.

Antifouling property: Each sample (measuring 1 cm square) is dipped in an aqueous dispersion (5 wt %) of carbon black (Vulcan XC-72) for 10 seconds and subsequently rinsed by dipping in pure water for 5 seconds. Then, the surface of the glass substrate is examined for the amount of carbon by X-ray photoelectron spectroscopy (XPS). Incidentally, in the case of examination of the comparative sample (C-1), the result was corrected by subtracting the contribution by carbon forming the C—F bond from the peak in the XPS spectrogram.

In addition, each sample was examined for change with time in characteristic properties (resistance to dust attraction and fouling) by repeatedly heating and cooling 100 times between 20° C. and 100° C.

TABLE 4

| | | Initial state | | After heat aging | |
|---|---|---|---|---|---|
| | | Resistance | Resistance | Resistance | Resistance |
| | Glass | to dust | to soiling | to dust | to soiling |
| | sub- | attraction | (Amount | attraction | (Amount |
| | strate | (Number | of carbon | (Number | of carbon |
| | (Glass- | of dust | on surface, | of dust | on surface, |
| | mold) | particles) | a.u.) | particles) | a.u.) |
| Example 1 | V1-H1 | 2 | 0.8 | 2 | 0.9 |
| | V1-H2 | 1 | 0.6 | 2 | 0.6 |
| | V2-H1 | 3 | 0.9 | 4 | 1.0 |
| | V2-H2 | 2 | 0.7 | 2 | 0.7 |
| | V3-H1 | 4 | 1.0 | 4 | 1.1 |
| | V3-H2 | 2 | 0.8 | 3 | 0.9 |
| | V4-H1 | 7 | 1.2 | 7 | 1.4 |
| | V4-H2 | 5 | 1.0 | 6 | 1.0 |
| | V1-M1 | 3 | 1.2 | 3 | 1.3 |
| | V1-M2 | 1 | 0.9 | 2 | 0.9 |
| | V2-M1 | 4 | 1.2 | 4 | 1.2 |
| | V2-M2 | 4 | 0.8 | 5 | 0.9 |
| | V3-M1 | 5 | 1.4 | 5 | 1.4 |
| | V3-M2 | 3 | 1.1 | 3 | 1.2 |
| | V4-M1 | 8 | 1.8 | 9 | 1.8 |
| | V4-M2 | 4 | 1.4 | 4 | 1.4 |
| | V1-L1 | 3 | 1.1 | 2 | 1.2 |
| | V1-L2 | 1 | 0.9 | 1 | 0.9 |
| | V2-L1 | 4 | 1.3 | 4 | 1.3 |
| | V2-L2 | 4 | 1.0 | 5 | 1.0 |
| | V3-L1 | 5 | 1.3 | 5 | 1.4 |
| | V3-L2 | 3 | 1.2 | 4 | 1.2 |
| | V4-L1 | 8 | 1.7 | 9 | 1.9 |
| | V4-L2 | 4 | 1.5 | 4 | 1.6 |
| | V1-S | 1 | 2.0 | 2 | 2.3 |
| | V2-S | 4 | 2.2 | 4 | 2.4 |
| | V3-S | 5 | 2.3 | 6 | 2.4 |
| | V4-S | 8 | 2.3 | 8 | 2.5 |
| Compar- | V1-P | 2 | 10.3 | 3 | — |
| ative | V2-P | 3 | 10.8 | 3 | — |
| Example 1 | V3-P | 4 | 10.8 | 4 | — |
| | V4-P | 7 | 11.1 | 8 | — |
| Compar- | C-1 | >20 | 1.4 | >20 | 3.4 |
| ative | | | | | |
| Example 2 | | | | | |

It is noted from Table 4 that the samples of glass substrate according to Example 1, which have the fine structure on the surface, are superior in antifouling property to the samples of glass substrate according to Comparative Example 1, which have no fine structure on the surface. A probable reason for this is that the glass substrate having the fine structure on the surface thereof has a large area of exposed hydrophilic surface. In addition, comparison between Example 1 and Comparative Example 2 reveals that the glass substrate according to the present invention has a good resistance to dust attraction. A probable reason for this is that the glass substrate according to Example 1 has a resistivity lower than 10⁹ Ω·cm, which prevents the generation of static electricity on the surface thereof, whereas the glass substrate according to Comparative Example 2 has a fluorine-based coating material which imparts insulating properties to the surface thereof. Furthermore, it is noted that the glass substrate according to Example 1 remains almost unchanged in antifouling property after heat-aging, whereas the one according to Comparative Example 2 decreases in antifouling property after heat-aging. A probable reason for this is that the glass substrate according to the present invention keeps the fine structure almost intact on the surface thereof after heat-aging, whereas the glass substrate according to Comparative Example 2 degrades in antifouling property because the fluorine-based coating material applied onto the surface thereof changes with time upon heat-aging. It is apparent from the foregoing results that the glass substrate according to the present invention is very little subject to dust attraction and retains the antifouling properties over a long period of time.

<Antifouling Glass Product Produced from the Glass Substrate According to the Present Invention>

First, a glass paste was prepared from glass powder, resin binder, and solvent. The glass powder is one which is composed of fine particles (smaller than 3 μm in diameter) obtained by pulverizing the glass V2 having the composition shown above. The resin binder is nitrocellulose. The solvent is butylcarbitol acetate. The glass paste was applied onto one side of float glass (Tempax Float (registered trademark), made by SCHOTT, measuring 914 by 813 mm long and 3 mm thick) so as to give a coating film having a thickness of 5 μm. The coating film underwent pressing by the mold L2 at 330° C. The pressing step was followed by cooling to 200° C. and demolding. In this way there was obtained the antifouling glass according to Example 2. This antifouling glass underwent heat treatment at 480° C. for 10 minutes so that it was made transparent to light having a wavelength longer than 600 nm. In this way there was obtained the antifouling glass according to Example 3. A probable reason why the heat treatment makes the glass transparent is that it changes the valence of V₂O₅ contained in the glass substrate from tetravalent to pentavalent, which alters the absorption band of V₂O₅. The antifouling glass according to Example 3 was found by spectrophotometry to have a sufficient light transmittance (higher than 80%) for light having wavelengths of 600 to 2000 nm. Incidentally, the light transmittance of the antifouling glass measured before heat treatment was higher than 80% for light having wavelengths longer than 1700 nm but was lower than 80% for light having wavelengths shorter than 1700 nm and about 30% for light having a wavelength of 600 nm. This result suggests that the heat treatment increases the light transmittance for light having wavelengths from 600 to 1700 nm.

A sample of antifouling glass according to Comparative Example 3 was prepared by dipping a piece of float glass (Tempax Float (registered trademark), made by SCHOTT, measuring 914 by 813 mm long and 3 mm thick) in Optool DSX (registered trademark) solution (made by Daikin Kagaku K.K.) for 30 minutes, followed by heat treatment at 120° C. for 5 minutes, so that the float glass has its surface covered with a antifouling coating layer. FIG. 9 schematically shows the samples of antifouling glass according to Example 2, Example 3, and Comparative Example 3.

The samples of antifouling glass according to Example 2, Example 3, and Comparative Example 3 were examined for resistance to dust attraction and fouling. The results are shown in Table 5. To evaluate resistance to dust attraction, each sample (measuring 1 cm square) cut out of the antifouling glass is allowed to stand indoors for two days, with that side having the fine structure upward. The result is rated in terms of the number of dust particles larger than 0.5 mm which have adhered to surface of the fine structure. Also, to evaluate antifouling property, each sample (measuring 1 cm square) cut out of the antifouling glass is dipped in an aqueous dispersion (5 wt %) of carbon black (Vulcan XC-72) for 10 seconds and subsequently rinsed by dipping in pure water for 5 seconds. Then, the surface of the sample is examined for the amount of carbon by X-ray photoelectron spectroscopy (XPS). Incidentally, in the case of examination of the comparative sample, the result was corrected by subtracting the contribution by carbon forming the C—F bond from the peak in the XPS spectrogram. In addition, each sample was examined for change with time in characteristic properties (resistance to dust attraction and fouling) by repeatedly heating and cooling 100 times between 20° C. and 100° C.

TABLE 5

| | Initial state | | After heat aging | |
|---|---|---|---|---|
| | Resistance | Resistance | Resistance | Resistance |
| | to dust | to soiling | to dust | to soiling |
| | attraction | (Amount of | attraction | (Amount of |
| | (Number of | carbon on | (Number of | carbon on |
| | dust | surface, | dust | surface, |
| | particles) | a.u.) | particles) | a.u.) |
| Example 2 | 2 | 1.0 | 2 | 1.0 |
| Example 3 | 1 | 0.9 | 2 | 0.9 |
| Comparative | >20 | 1.3 | 20 | 3.3 |
| Example 3 | | | | |

Table 5 shows the results of examination of the antifouling glass for resistance to dust attraction and fouling. Comparison between the result of Examples 2 and 3 and the result of Comparative Example 3 reveals that the antifouling glass according to the present invention is superior in antifouling property to the comparative one. A probable reason for this is that the glass substrate according to Examples 2 and 3 has a resistivity lower than 10⁹ Ω·cm, which prevents the generation of static electricity on the surface thereof, whereas the glass substrate according to Comparative Example 3 has a fluorine-based coating material which imparts insulating properties to the surface thereof.

Furthermore, it is noted that the glass substrate according to Examples 2 and 3 remains almost unchanged in antifouling property after heat-aging, whereas the one according to Comparative Example 3 decreases in antifouling property after heat-aging. A probable reason for this is that the glass substrate according to the present invention keeps the fine structure almost intact on the surface thereof after heat-aging, whereas the glass substrate according to Comparative Example 3 degrades in antifouling property because the fluorine-based coating material applied onto the surface thereof changes with time upon heat-aging. It is apparent from the foregoing results that the glass substrate according to the present invention is very little subject to dust attraction and retains the antifouling properties over a long period of time.

<Infrared Sensor Provided with the Glass Substrate According to the Present Invention>

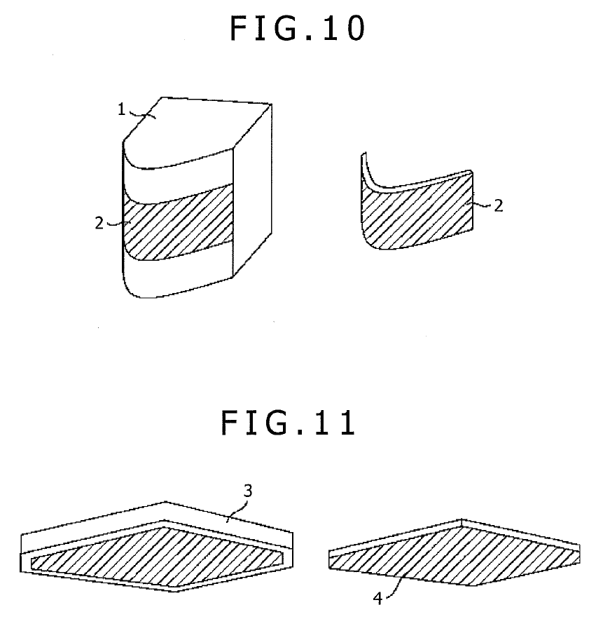

First, a glass paste was prepared from glass powder, resin binder, and solvent. The glass powder is one which is composed of fine particles (smaller than 3 μm in diameter) obtained by pulverizing the glass V2 having the composition shown in Table 1. The resin binder is nitrocellulose. The solvent is butylcarbitol acetate. The glass paste was applied onto the sensor window glass so as to give a paste coating film having a thickness of 5 μm. The coating film underwent heat treatment at 330° C. Incidentally, the sensor window glass was formed from Tempax Float (registered trademark) (made by SCHOTT) in a mold at 1300° C. The thus formed sensor window glass underwent sandblasting with aluminum oxide (325 mesh, made by Wako Junyaku Kogyo K.K.) at a pressure of 0.8 MPa for 10 seconds, so that the sensor window glass had the fine structure formed on the surface thereof. The sensor window glass 2 thus prepared was mounted on the casing 1 of the infrared sensor. In this way there was obtained the infrared sensor according to Example 4. FIG. 10 schematically shows the appearance of the infrared sensor and the sensor window glass thereof.

On the other hand, the sensor window glass formed from Tempax Float (registered trademark) in a mold at 1300° C. was dipped in Optool DSX (registered trademark) solution (made by Daikin Kagaku K.K.) for 30 minutes, followed by heat treatment at 120° C. for 5 minutes, so that the sensor window glass has its surface covered with a antifouling coating layer. The sensor window glass thus obtained was mounted on the infrared sensor. In this way there was obtained the infrared sensor according to Comparative Example 4. The infrared sensor and the sensor window glass according to Comparative Example 4 have the same appearance as those according to Example 4 which are shown in FIG. 10.

The samples of the infrared sensors obtained in Example 4 and Comparative Example 4 underwent weathering test for 3 months under the same outdoor conditions. They were examined for change in infrared detection sensitivity. Incidentally, the detector element is an InSb diode and the wavelengths of infrared rays for detection range from 1.5 to 5 μm. The sample of Comparative Example 4 decreased in sensitivity by 10% after 3 months. A probable reason for this is that the sensor window glass became fouled to reduce infrared transmittance after outdoor exposure for 3 months. By contrast, the sample of Example 4 decreased in sensitivity by only 2% after 3 months. A probable reason for this is that the sensor window glass pertaining to the present invention remained sufficiently clean for infrared transmission without dust adhesion and fouling even after outdoor exposure for 3 months.

<Illuminating Lamp Provided with the Glass Substrate According to the Present Invention>

First, a glass paste was prepared from glass powder, resin binder, and solvent. The glass powder is one which is composed of fine particles (smaller than 3 μm in diameter) obtained by pulverizing the glass V2 having the composition shown in Table 1. The resin binder is nitrocellulose. The solvent is butylcarbitol acetate. The glass paste was applied onto the cover glass of the illuminating lamp so as to give a paste coating film having a thickness of 5 μm. The coating film underwent heat treatment at 330° C. Incidentally, the cover glass of the illuminating lamp was formed from Tempax Float (registered trademark) (made by SCHOTT) in a mold at 1300° C. Thereafter, the cover glass of the illuminating lamp underwent heat treatment at 480° C. for 10 min. The thus formed cover glass underwent sandblasting with aluminum oxide (325 mesh, made by Wako Junyaku Kogyo K.K.) at a pressure of 0.8 MPa for 10 seconds, so that the cover glass had the fine structure formed on the surface thereof. The cover glass 4 thus prepared was mounted on the casing 3 of the illuminating lamp. In this way there was obtained the illuminating lamp according to Example 5. FIG. 11 schematically shows the appearance of the illuminating lamp and the cover glass thereof according to Example 5.

On the other hand, the cover glass of the illuminating lamp which was formed from Tempax Float (registered trademark) in a mold at 1300° C. was dipped in Optool DSX (registered trademark) solution (made by Daikin Kagaku K.K.) for 30 minutes, followed by heat treatment at 120° C. for 5 minutes, so that the cover glass has its surface covered with a antifouling coating layer. The cover glass thus obtained was mounted on the illuminating lamp. In this way there was obtained the cover glass for the illuminating lamp according to Comparative Example 5. The illuminating lamp and the cover glass thereof according to Comparative Example 5 have the same appearance as those according to Example 5 which are shown in FIG. 11.

The samples of the cover glass of the illuminating lamp which were obtained in Example 5 and Comparative Example 5 underwent weathering test for 3 months under the same outdoor conditions. They were examined for change in illuminance. Incidentally, the illuminating lamp has a high-pressure Na lamp as the illuminant. The wavelengths of light for measurement of illuminance range from 600 to 800 nm. The sample of Comparative Example 5 decreased in illuminance by 12% after 3 months. A probable reason for this is that the cover glass became fouled to reduce light transmittance after outdoor exposure for 3 months. By contrast, the sample of Example 5 decreased in light transmittance by only 3% after 3 months. A probable reason for this is that the cover glass pertaining to the present invention remained sufficiently clean for light transmission without dust adhesion and fouling even after outdoor exposure for 3 months.

What is claimed is:

1. A glass substrate having a fine structure on the surface thereof, wherein said glass substrate is made of vanadium-containing glass, and said vanadium-containing glass has a resistivity no higher than 10⁹ Ω·cm.

2. The glass substrate as defined in claim 1, wherein the vanadium-containing glass contains V₂O₅, and the content of V₂O₅ is no less than 10 wt % and no more than 60 wt %.

3. The glass substrate as defined in claim 1, wherein the fine structure on the surface thereof is the one which is composed of projections and recesses having minimum dimensions no larger than 50 μm.

4. Antifouling glass having the glass substrate of claim 2 on part or all of the surface thereof.

5. An infrared sensor having a sensor window on the casing thereof, wherein said sensor window is made of the glass substrate defined in claim 2.

6. An illuminating lamp whose casing is provided with a cover glass, wherein said cover glass is made of the glass substrate defined in claim 2.
